(19) United States
(12) Patent Application Publication
(10) Pub. No.: US 2019/0292048 A1
(43) Pub. Date: Sep. 26, 2019

(54) METHOD FOR PROVIDING HYDROGEN GAS, DEHYDROGENATION REACTOR AND TRANSPORT CONTAINER

(71) Applicant: HYDROGENIOUS TECHNOLOGIES GmbH, Erlangen (DE)

(72) Inventors: Matthias KUSCHE, Schwaig (DE); Caspar PAETZ, Erlangen (DE); Federico WESTERATH, Altdorf (DE); Berthold MELCHER, Erlangen (DE); Cornelius RANDIG, Erlangen (DE); Martin SCHNEIDER, Erlangen (DE); Daniel TEICHMANN, München (DE)

(21) Appl. No.: 16/461,161

(22) PCT Filed: Oct. 24, 2017
(86) PCT No.: PCT/EP2017/077172

§ 371 Date: May 15, 2019

(30) Foreign Application Priority Data
Nov. 16, 2016 (DE) 10 2016 222 596.0

(51) Int. Cl. C01B 3/22; C01B 3/00; C01B 3/58

(52) U.S. Cl. CPC C01B 3/22; C01B 3/0015; C01B 3/58; C01B 2203/0872; C01B 2203/042; C01B 2203/085; C01B 2203/0277

(57) ABSTRACT

A method for providing hydrogen gas includes the process steps pre-heating of an at least partially hydrogenated hydrogen carrier material, release of hydrogen gas by at least partial dehydrogenation of the hydrogen carrier material, purification of the released hydrogen gas as well as cooling and conditioning of the at least partially dehydrogenated hydrogen carrier material.

### CROSS REFERENCE TO RELATED APPLICATIONS

This application is a United States National Phase Application of International Application PCT/EP2017/077172 filed Oct. 24, 2017 and claims the benefit of priority under 35 U.S.C. § 119 of German Patent Application Serial No. DE 10 2016 222 596.0, filed on Nov. 16, 2016, the entire contents of which are incorporated herein by reference.

### FIELD OF THE INVENTION

The invention relates to a method for providing hydrogen gas, a dehydrogenation reactor as well as a transport container.

### BACKGROUND OF THE INVENTION

From EP 1 475 349 A2, a method for storage and release of hydrogen gas on a hydrogen carrier material is known.

### SUMMARY OF THE INVENTION

It is an object of the invention to improve the release of hydrogen gas in a way that hydrogen gas can be provided with increased quality, in particular purity, by means of a method that is robust and feasible with regard to economic points of view.

This object is achieved by a method for providing hydrogen gas comprising the process steps pre-heating of an at least partially hydrogenated hydrogen carrier material, release of hydrogen gas by means of at least partial dehydrogenation of the hydrogen carrier material, purification of the released hydrogen gas, cooling and conditioning of the at least partially dehydrogenated hydrogen carrier material, by a dehydrogenation reactor comprising a reactor housing, at least one catalyst mount arranged in the reactor housing, wherein a catalyst carrier with catalyst material is arranged at said at least one catalyst mount, a heating unit for heating the at least one catalyst mount, a distribution unit for uniform distribution of an intake flow of at least partially hydrogenated hydrogen carrier material on the at least one catalyst mount, at least one outlet opening for continuous discharge of hydrogen gas and at least partially dehydrogenated hydrogen carrier material from the dehydrogenation reactor and by a transport container in which the dehydrogenation reactor is arranged. The core of the invention is to combine the process steps necessary for providing hydrogen gas in such an advantageous way that hydrogen with increased purity, under robust and economic circumstances, can be released by a hydrogen carrier material, in particular an organic liquid, also known as liquid organic hydrogen carrier (LOHC). According to the invention, it has been found that a pre-heating of the at least partially hydrogenated hydrogen carrier material is energy-efficient for the entire process. Depending on the reaction conditions and the charge of the hydrogen carrier material, a more or less complete discharging, i.e. dehydrogenation, is possible. In particular, the added LOHC material is not entirely hydrogenated. A hydrogenation degree, typically, is between 50% and 100%, preferably between 80% and 95%. After dehydrogenation, the hydrogenation degree, for example, is between 0% and 50%, but may also be higher.

By purification of the released hydrogen gas, the quality, in particular the purity of the hydrogen gas is improved. A cooling and conditioning of the at least partially dehydrogenated hydrogen carrier material ensures an increased safety in storing and handling the hydrogen carrier material. In particular, the at least partially dehydrogenated hydrogen carrier material is cooled to a target temperature of less than 60° C., in particular less than 50° C. and in particular to about 40° C. At this temperature, a secure handling and storage of the hydrogen carrier material, in particular of LOHC, is safely possible. The safety risk is reduced. The conditioning includes in particular the removal of physically dissolved residual hydrogen gas from the hydrogen carrier material. The method according to the invention is in particular also economically feasible with small facilities. Such small facilities can be run in a decentralized manner. In the following, a transportable facility, in particular inside a transport container, is to be understood as small facility. Such a small facility has a maximum power of 5 MW. Supplying the small facility with hydrogen carrier material is carried out by means of truck transport, so in particular not by means of ship, train or pipelines. The transport of hydrogen carrier material is flexibly possible by road as to time and place. The method is possible in particular by means of a dehydrogenation reactor, which can be arranged in a transport container known as such. By means of the transport container, the dehydrogenation reactor can be transported to a decentralized application site and be run there, flexibly and without complications.

A pre-heating of the hydrogen carrier material that comprises a contacting with the released hydrogen gas and/or with the at least partially dehydrogenated hydrogen carrier material allows for efficient and direct supply of heat. It is advantageous when the educt, i.e. the at least partially hydrogenated hydrogen carrier material, is heated by means of an emergent product flow of dehydrogenation. The product flow of dehydrogenation comprises the released hydrogen gas and the at least partially dehydrogenated hydrogen carrier material. The latently present heat in the product flow is directly used for pre-heating the hydrogen carrier material. The efficiency of the method is increased. The released hydrogen gas and the at least partially dehydrogenated hydrogen carrier material are available at reaction temperature, which is present at about 300° C. As a result of the educt flow being in direct contact with at least one of the educt flows, in particular in the form of a counterflow washer or an injection condenser, besides the efficient heat recovery for increasing efficiency, a separation of impurities of the released hydrogen gas and/or the at least partially dehydrogenated hydrogen carrier material is possible, as well. The pre-heating can be carried out by direct or indirect contact by means of the product flows. The pre-heating can be carried out by contacting the released hydrogen gas or the at least partially dehydrogenated hydrogen carrier material, or a mixture of both of them.

The release of hydrogen gas that takes place at a process pressure of more than 1 bar, in particular between 2 bar and 10 bar, in particular between 2.5 bar and 5 bar, and/or at a process temperature of more than 200° C., in particular between 250° C. and 350° C., in particular between 270° C. and 310° C., is possible in a particularly advantageous way. The reaction conditions favor an efficient release.

The purification of the released hydrogen gas that comprises the separation of at least one impurity, wherein the at least one impurity is present in solid, liquid or gaseous aggregate state, wherein in particular the separation into at least one separation stage is carried out, wherein in particular the at least one separation stage serves for separating an impurity in a specific aggregate state, is efficient: By this means, it is possible to ensure a required purity of the hydrogen gas of up to 99.999%, which is required in particular for the use of the hydrogen gas in a fuel cell or for the food industry. According to the invention, it has been found that the purification can be variably predefined depending on the subsequent application purpose of the released hydrogen gas. In particular, methane impurities are comparably unproblematic for the use of the hydrogen gas in fuel cells. Carbone monoxide impurities, on the contrary, are to be avoided for the use of the hydrogen gas in a fuel cell. Hydrocarbon impurities are rather unproblematic for the use of hydrogen gas as fuel gas, whereas hydrocarbon impurities are not acceptable in the food industry. The impurities to be separated can be available in solid, liquid or gaseous aggregate state. An impurity may for example be given in the form of aerosol drops in the hydrogen gas.

A separation into at least one separation stage allows for the specific separation of impurities depending on their aggregate state. In particular, it is possible by this means to provide for an individual separation stage for each aggregate state of an impurity, i.e. solid, liquid or gaseous. Knowing the present impurities, an efficient purification of the hydrogen gas is possible. In particular, the separation is carried out in several stages, i.e. with several, series-connected separation stages. A solid material impurity may for example be coke, i.e. strongly carboniferous fuel with high specific surface. A liquid impurity may be present in the form of LOHC and/or aerosol drips. Gaseous impurities may be present in the form of carbon monoxide, methane, carbon dioxide and/or water vapor, as well as in the form of volatile hydrocarbons, such as toluene or cyclohexane.

A pressure increase of the gas phase for purification of the released hydrogen gas, by ionic, thermal and/or mechanical compression, allows for an improvement of the total efficiency of the process. The increased efficiency results from the fact that more usable product gas, i.e. hydrogen gas, per amount of material used, i.e. LOHC, is available. The higher the pressure during pressure swing adsorption, the higher the yield of usable product gas. It has proven particularly advantageous to provide for a pressure increase of the released hydrogen gas. The pressure increase may be carried out as intermediate compression by ionic, thermal and/or mechanical compression.

Separation processes in which the separation shows at least one of the methods coalescence precipitation, cyclone separation, adsorption separation, counterflow washer or injection into a washing liquid, wherein the adsorption separation comprises in particular a pressure swing adsorption and/or a temperature change adsorption, allow for an advantageous purification. In particular, adsorptive processes or a conversion of the gaseous impurities via chemical reactions serve for the separation of gaseous impurities.

In particular, it has been found that adsorption processes, in particular a pressure swing adsorption process, can be carried out especially efficiently with high gas pressures.

In pressure swing adsorption, gas is conducted under increased pressure of at least 5 bar, in particular at least 10 bar and in particular at least 15 bar to a reactor, in particular a fixed bed reactor filled with the adsorbent. One or more components of the gas, the so-called heavy components, are adsorbed. At the outlet of the reactor, the so-called light component, which cannot be adsorbed, can be extracted in concentrated form. After saturation of the adsorbent, the heavy, adsorbing component, can be released, i.e. desorbed, by pressure drop and be discharged separately.

In addition, the adsorptive separation can be carried out in the form of pressure swing adsorption and/or temperature change adsorption. The temperature in a possible temperature change adsorption usually is less than 100° C., in particular less than 60° C. and in particular less than 30° C. The purity of the hydrogen gas may be improved by this means. The regeneration of the adsorbent takes place at a temperature of at least 100° C., in particular at least 150° C. and in particular at least 200° C. The hydrogen-containing mixture of gases discharged during regeneration of the adsorbent may be supplied to further increase the degree of efficiency of the process of a thermal utilization, in particular of a combustion.

A separation that comprises a catalytic conversion of the at least one impurity allows for the advantageous conversion of a gaseous impurity by means of catalytically active materials installed in the product flow. It has been found that the reaction conditions present in the product flow correspond to those of a catalytic gas-phase reaction, as for example the methanation of carbon monoxide. Thus, an especially efficient post-conditioning of the hydrogen gas is possible. A separate, additional reactor for conditioning the released hydrogen gas is superfluous. In particular, the purification of the hydrogen gas can be provided as an integral process step upon provision of the hydrogen gas. The separation of liquid impurities, as for example aerosol, is efficiently possible in multistage separation processes. By means of a coalescence filter, the drop size of the aerosols can be first increased and then efficiently separated from the gaseous phase of the product flow by means of a subsequent blade separation.

A controlled purification, which takes place until a, in particular variably, adjustable degree of purity of the hydrogen gas is achieved, ensures the provision of the hydrogen gas with the required purity. The purification can be adjusted efficiently variably. On the one hand, it is ensured that the hydrogen gas has the required purity. On the other hand, it is ensured that excessive purification, i.e. the purification up to a degree of purity that is technically not necessary, does not happen. An over-purification, i.e. the purification exceeding a required degree of purity, is avoided. The required effort for purification is controllable. In particular, it is advantageous to monitor the current degree of purity continuously be means of appropriate sensors, and to adjust it by means of a control unit. A typical degree of purity may be 99.999% for the hydrogen gas.

A cooling that takes place by means of an additional cooling unit is possible in an especially efficient way. In particular, in case a cooling by direct or indirect contacting with the product flows alone is not possible sufficiently or sufficiently quickly, an additional cooling unit may be provided.

An extraction of hydrogen gas that is in particular physically dissolved on the at least partially dehydrogenated hydrogen carrier material, such that after the conditioning of the hydrogen carrier material a residual portion of physically dissolved hydrogen gas in the at least partially dehydrogenated hydrogen carrier material is between 1 and 10 grams ppm by weight, improves the storage conditions of the hydrogen carrier material. Thus, the risk of an explosive hydrogen atmosphere in a storage tank can be reduced for the at least partially dehydrogenated hydrogen carrier material. An explosive hydrogen atmosphere in a storage container can be produced through the at least partially dehydrogenated hydrogen carrier material being stored for a longer period of time without sufficient air supply above the liquid phase and hydrogen degassing in the course of this. The separation of the physically dissolved hydrogen gas can take place in one stage or several stages by separation. In a first stage, a distribution unit similar to a shower head can be used, which is connected with a stripping column or a spray tower. In addition or alternatively, a flushing gas, in particular an inert gas such as nitrogen or argon or compressed air, may be used to discharge hydrogen gas from a column. In addition or alternatively to a flushing gas, a low pressure, in particular a vacuum, may be applied for discharging the hydrogen gas. It is advantageous, if the content of hydrogen remaining in the hydrogen carrier material is between 0.1 and 10 ppm by weight. Even if hydrogen gas degases during the storage of the hydrogen carrier material over a longer period of time, the hydrogen concentration in the storage container reached by this means will be lower than an explosion limit of the hydrogen in air and/or of the air with shares of LOHC. The risk of explosion resulting from degassing hydrogen may also be reduced in such a way that the air buffer within the storage container is configured relatively large by limiting the maximum admissible filling degree typically to 80% of the container volume. Thus, it is ensured that even with degassing hydrogen gas, the critical explosion limit will not be reached. The conditioning of the hydrogen carrier material ensures a permanent reliable storage thereof.

It is also conceivable to provide a separation stage for impurities in solid state, in particular as rubbed-off parts of the catalyst material.

A dehydrogenation reactor comprising a reactor housing, at least one catalyst mount arranged in the reactor housing, wherein a catalyst carrier with catalyst material is arranged at said at least one catalyst mount, a heating unit for heating the at least one catalyst mount, a distribution unit for uniform distribution of an intake flow of at least partially hydrogenated hydrogen carrier material on the at least one catalyst mount, at least one outlet opening for continuous discharge of hydrogen gas and at least partially dehydrogenated hydrogen carrier material from the dehydrogenation reactor, allows for an advantageous execution of the process. The advantages of the dehydrogenation reactor essentially correspond to the advantages of the method, to which reference is made herewith. It has been found that the catalyst material can be arranged advantageously in at least one catalyst mount arranged in a reactor housing. The catalyst mount can be a pipe, a plate or a combination configured thereof. The distribution unit may advantageously have capillaries, flow breakers and/or distribution trays. At least one outlet opening allows for continuous discharge of hydrogen gas and hydrogen carrier material. There may as well be two outlet openings provided, whereas a rough separation in gaseous and in liquid phases of the product flows can be distinguished. A phase separator, which in particular serves for distributed supply of the at least partially dehydrogenated hydrogen carrier material, may comprise an integrated distribution unit, which serves for generating large specific surfaces. The distribution unit can be configured as a stripping column, as an extruder, as a spray tower or as a combination of these units.

Using a catalyst material such as platinum, palladium, nickel, rhodium and/or ruthenium, each with a weight portion of 0.1% to 10% with reference to the, in particular inert, catalyst carrier allows for an efficient release of the hydrogen gas.

A catalyst carrier that comprises aluminum oxide, silicon oxide, silicon carbide and/or activated carbon allows for advantageous attachment of the catalyst material. The catalyst carrier material favors the strongly endothermic dehydrogenation reaction in the dehydrogenation reactor. It is advantageous if the catalyst carrier material is an inert material. In addition, inert supplementary material, for example in the form of glass balls, metal balls or metallic structures such as tubes, nets or grids may be attached to the inside or to the mounts on the outside. The inert supplementary material, for example, serves for diluting the catalyst material and/or for holding the catalyst carrier material. For example, a setup is conceivable including a net of inert supplementary material, on which glass balls are provided for diluting the catalyst material, wherein catalyst material is arranged on the glass balls. For example, it is conceivable that the inert catalyst carrier material and the inert supplementary material are similar and in particular identical. In particular, the inert catalyst carrier material differs from the inert supplementary material by a metallic coating.

A heating unit that has a sleeve filled with liquid, vapor and/or gas and/or an electric heater ensures an efficient heating. The heating unit favors the strongly endothermic dehydrogenation reaction in the dehydrogenation reactor.

A transport container in which the dehydrogenation reactor is arranged, which comprises a reactor housing, at least one catalyst mount arranged in the reactor housing, wherein a catalyst carrier with catalyst material is arranged at said at least one catalyst mount, a heating unit for heating the at least one catalyst mount, a distribution unit for uniform distribution of an intake flow of at least partially hydrogenated hydrogen carrier material on the at least one catalyst mount, at least one outlet opening for continuous discharge of hydrogen gas and at least partially dehydrogenated hydrogen carrier material from the dehydrogenation reactor, allows for a flexible, location-independent and decentralized application of the method for providing hydrogen.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic side view of a transport container with a dehydrogenation reactor according to the invention;

FIG. 2 is an enlarged schematic side view of the dehydrogenation reactor in FIG. 1;

FIG. 3 is a schematic view, corresponding to FIG. 1, of a transport container with a dehydrogenation reactor according to a second embodiment,

FIG. 4 is an enlarged schematic side view of the dehydrogenation reactor in FIG. 3; and

FIG. 5 is an enlarged schematic side view of an LOHC conditioning unit in FIG. 3.

### DESCRIPTION OF THE PREFERRED EMBODIMENTS

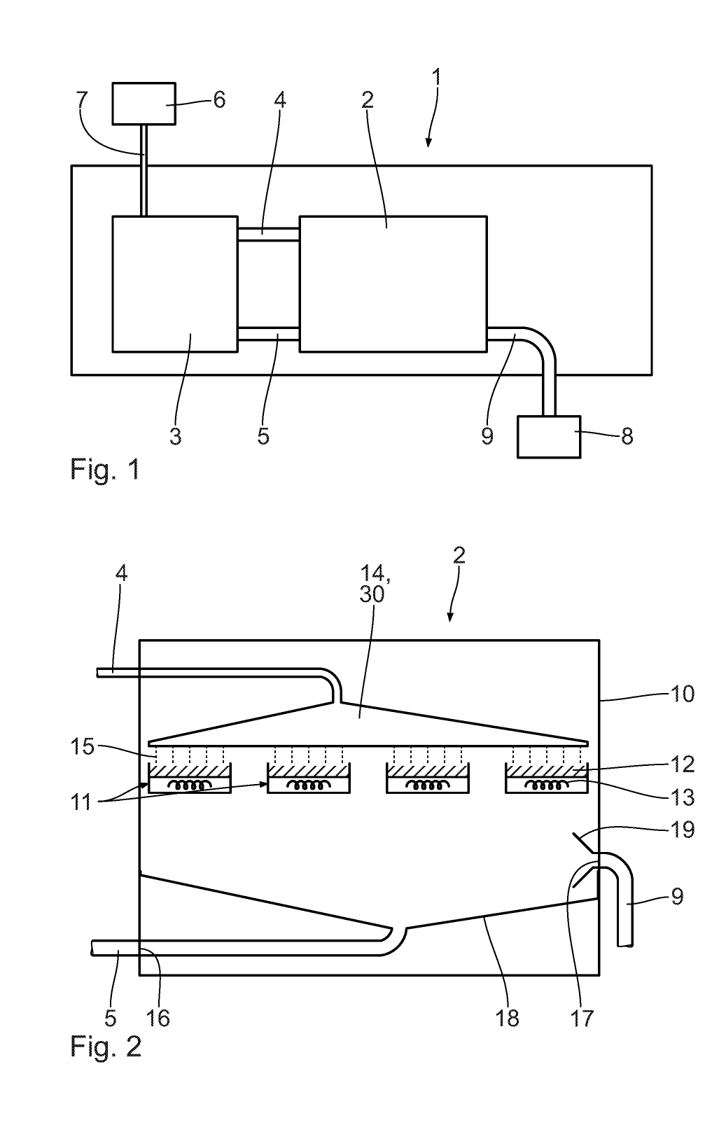

A transport container 1 shown in FIG. 1 is known as such and can be transported without complications with a ship, a truck and/or a railroad car. The transport container 1 has standardized dimensions.

In the transport container 1, a dehydrogenation reactor 2 is arranged, which is connected with an LOHC storage container 3 by means of an LOHC supply line 4 and an LOHC output line 5. LOHC serves as a hydrogen carrier medium. The LOHC storage container 3 is connected by means of an LOHC source 6 via a line 7. The LOHC storage container 3, according to the embodiment shown, serves for storing of charged LOHC, which is discharged, i.e. dehydrogenated, in the dehydrogenation reactor 2 by release of hydrogen gas.

Additionally, a further storage container, which is not shown, may be provided, in which the hydrogen carrier medium that is discharged in the dehydrogenation reactor 2 is stored. This means that in particular two separate LOHC storage containers are provided; one for the charged, i.e. high-energy LOHC, and one for the discharged, i.e. low-energy LOHC. The two storage containers can be arranged inside the transport container 1 or outside the transport container 1.

For example, it is also possible that large LOHC storage containers, respectively, are arranged outside the transport container 1 in order to ensure a sufficient, long-term supply with LOHC. Inside the transport container, smaller LOHC storage containers can be provided as buffer containers in order to ensure an operation of the transport container even when the supply with LOHC medium from the storage containers arranged outside the transport container 1—in particular temporarily—is not ensured.

The LOHC source 6 can be an external source such as, for example, an LOHC transport vehicle. In addition or alternatively, the LOHC source 6 may also have a hydrogenation reactor that serves for charging, i.e. for at least partially hydrogenating of LOHC as hydrogen carrier material. For this purpose, at least partially uncharged LOHC is charged with hydrogen gas in the hydrogenation reactor, which is not shown. The hydrogen gas may, for example, originate from an electrolysis in an electrolyzer, which is not shown. The electrolyzer, for example, is fed with electricity from wind energy and/or photovoltaic systems. The energy supply of the electrolyzer may also be provided by a, in particular public, power grid.

The LOHC source 6 is connectable to the LOHC storage container 3, in particular via the line 7. The LOHC source 6 is arranged in particular outside the transport container 1. The line 7 may have a suitable interface in order to generate an uncomplicated connectivity with the LOHC source 6. The LOHC source 6 is arranged, in particular stationarily, in a place of electricity generation. It is also conceivable to integrate, at least partially, the LOHC source 6, in particular in the form of the hydrogenation reactor and/or the electrolyzer, in the transport container 1.

The LOHC supply line 4 serves for supplying at least partially hydrogenated LOHC from the LOHC storage container 3 into the dehydrogenation reactor 2. The LOHC output line 5 serves for discharging at least partially dehydrogenated LOHC from the dehydrogenation reactor 2 into the LOHC storage container 3.

The dehydrogenation-reactor 2 is connected with a hydrogen consumer 8 via a hydrogen line 9. The hydrogen consumer 8 is configured as a fuel cell and allows for a conversion of the hydrogen generated in the dehydrogenation reactor 2 into electricity. Other hydrogen uses are possible, as well. It is also conceivable to integrate the hydrogen consumer 8 in the transport container 1 in the form of the fuel cell in order to provide electric power for an electricity consumer and/or a power grid for feeding in. In addition or alternatively to the hydrogen use by the fuel cell, for example a thermal utilization of the hydrogen and/or providing the hydrogen for material use, in particular in the food industry, is conceivable.

In the following, the dehydrogenation reactor 2 will be described in more detail referring to FIG. 2. The dehydrogenation reactor 2 has a reactor housing 10, in which a number of catalyst mounts 11 are arranged. On each catalyst mount 11, a catalyst carrier with catalyst material 12 is arranged. According to the embodiment shown, the catalyst mounts 11 are lying, i.e. are arranged essentially horizontally. It is also conceivable to arrange the catalyst mounts 11 in an inclined manner relative to the horizontal and in particular perpendicularly. The catalyst mounts 11 with the catalyst material 12 configure a catalyst fixed bed. The dehydrogenation reactor 2 can be operated in a one-stage manner.

On the catalyst mounts 11, a heating unit 13, respectively, is provided to allow for a direct an efficient heating of the catalyst material 12. The heating unit 13, in particular, is integrated in the catalyst mount 11. The heating unit 13, in particular, is configured as a sleeve filled with liquid, vapor and/or gas and/or an electric heater.

In the reactor housing 10, an LOHC distribution unit 14 is connected with the LOHC supply line 4. The LOHC distribution unit 14 is essentially configured in the form of a shower head and allows for a distributed supply of the LOHC 15 to the catalyst material 12 on the catalyst mounts 11. Instead of the shower head, the LOHC distribution unit 14 may also be configured as a capillary plate, as a flow breaker and/or as a distribution tray.

Additionally, the shower head may also be configured as a unit for surface enlargement 30. The unit for surface enlargement 30 allows for advantageous surface enlargement of the LOHC 15 upon supply to the catalyst mounts 11. Thus, the subsequent dehydrogenation reaction is favored, since the educt, i.e. the charged LOHC 15, has a comparably large surface to react with the catalyst material 12 arranged in the catalyst mounts 11. The unit for surface enlargement of the LOHC may also be provided separately and in particular in an embodiment deviating from a shower head.

The dehydrogenation reactor 2 has an LOHC outlet opening 16 and a hydrogen gas outlet opening 17. By means of a collection facility 18, at least partially dehydrogenated LOHC 15 is discharged from the dehydrogenation reactor 2 via the LOHC outlet opening 16 and the LOHC output line 5. The collection facility 18 may be a bell-mouthed collection tank with an output line. Other embodiments of the collection facility 18 are conceivable, as well.

In the area of the hydrogen gas outlet opening 17, a suction device 19 may be provided in order to support the outlet of the hydrogen on the dehydrogenation reactor 2. The dehydrogenation reaction may be accelerated by means of the suction device 19. However, the suction device may be dispensed with. In particular, in case the release takes place at a process pressure of more than 1 bar, the released hydrogen gas can escape without any additional pressure conveying units, such as compressors, from the dehydrogenation reactor 2. Then, it is advantageous to adapt the pressure of the hydrogen gas to possibly required, subsequent purification steps for the hydrogen gas.

In the following, the function of the dehydrogenation reactor 2, according to a first method, will be described in more detail. An educt flow with at least partially hydrogenated LOHC as hydrogen carrier medium is supplied from the LOHC storage container 3 via the LOHC supply line 4 to the dehydrogenation reactor 2. Before the supply, the LOHC educt is pre-heated with at least partially dehydrogenated hydrogen carrier material, i.e. LOHC product, from the dehydrogenation reactor 2. For this purpose, the LOHC supply line 4 and the LOHC outlet line 5 can be guided together, at least section-wise, in order to allow for a direct contacting of LOHC educt and LOHC product, in particular in the counterflow process.

The dehydrogenation of the at least partially charged hydrogen carrier material takes place in the dehydrogenation reactor 2 at a reaction pressure of 2.5 bar and a reaction temperature of 310° C. The released hydrogen gas is purified and cooled by means of a purification unit, which is not shown. In particular, a catalytic conversion of carbon monoxide to methane takes place in a coated wire grid and in a fixed bed adsorption. The released hydrogen gas is supplied to the fuel cell 8, via the hydrogen outlet opening 17 and the hydrogen line 9, for conversion into electricity.

The LOHC product, which has already been used for pre-heating the LOHC educt, depending on the residual heat, is cooled in a separate cooler, which is not shown, and afterwards supplied to a conditioning unit in the form of a stripping column, which is not shown, in order to remove residual hydrogen, which is in particular physically bound.

According to a further embodiment of the method according to the invention, hydrogen gas can be provided for direct combustion. For this purpose, LOHC educt is conveyed to the dehydrogenation reactor 2. Before the supply, the LOHC product, with the hydrogen gas carried along therein, serves for pre-heating the LOHC educt by direct contacting. Thus, in this case, hydrogen and LOHC educt are discharged via a common outlet opening and outlet line from the dehydrogenation reactor 2.

The dehydrogenation reaction takes place at a pressure of 2.5 bar and at a temperature of 310° C. After the pre-heating of the LOHC educt, the product flow is roughly separated in a phase separator into a mainly hydrogen-containing, gaseous product flow and a mainly LOHC-containing, liquid product flow. The liquid LOHC product is freed from residual hydrogen by means of a cooler and by vacuum degassing. The gaseous hydrogen flow makes a further conditioning superfluous and can be used directly for combustion.

According to a further embodiment of the method, hydrogen gas can be used for the food industry. For this purpose, LOHC educt is conveyed to the dehydrogenation reactor 2. Beforehand, it is pre-heated against LOHC product. The dehydrogenation reaction takes place at 2.5 bar and 310° C. The released hydrogen gas is purified through catalytic conversion from carbon monoxide to methane in a coated wire grid and subsequent separation of liquid parts in a washing column and using a pressure swing adsorption. As against fixed bed adsorption, the pressure swing adsorption has the advantage that the product is gas-free of carbon monoxide (CO) and methane (CH₄). The LOHC product, after being used for pre-heating the LOHC educt, is freed from residual hydrogen by means of a cooler and a stripping column.

The method according to the invention for providing hydrogen gas can serve for further application purposes, such as for example the use of hydrogen as protective gas, the inclusion of further purification stages in the hydrogen product flow and/or a hydrogen separation in the product flow of the hydrogen carrier material.

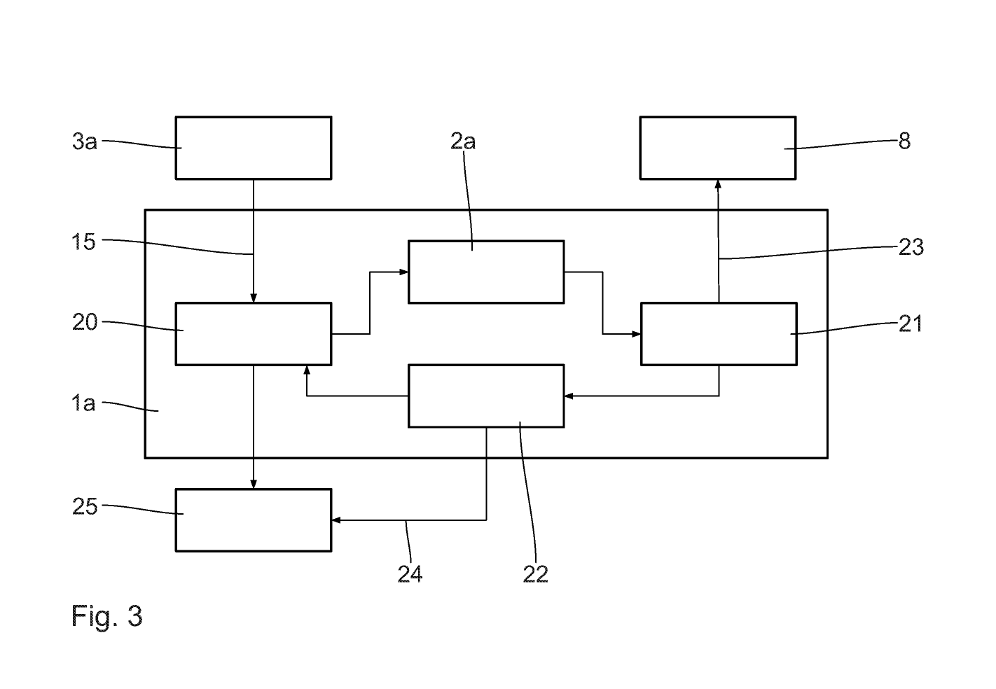

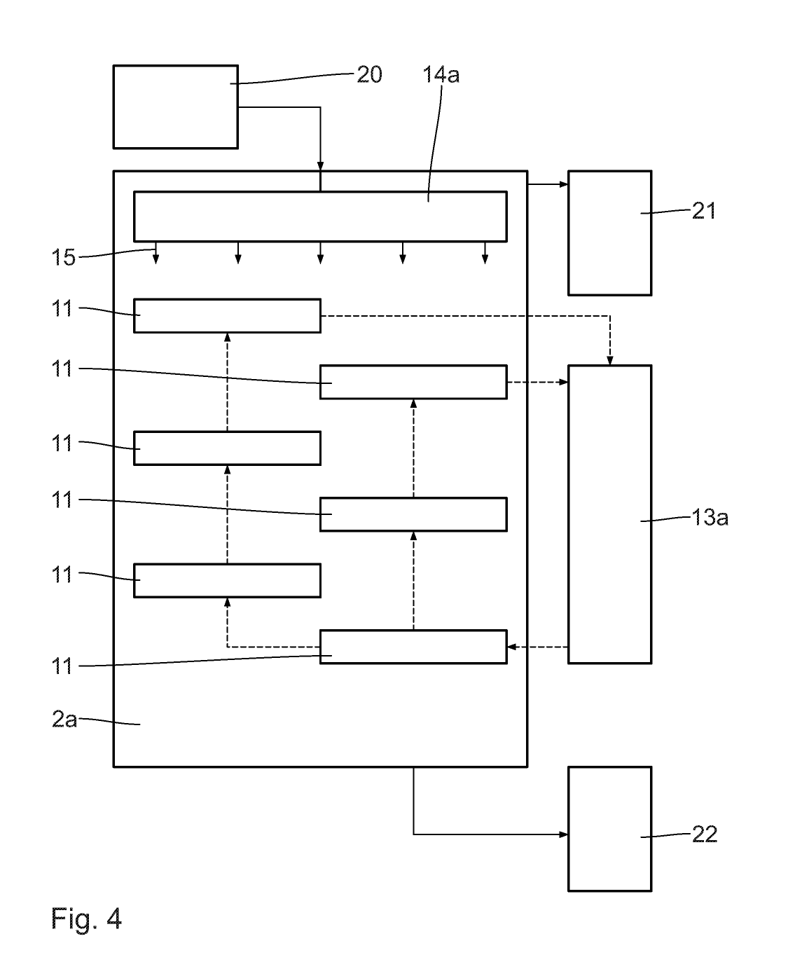

In the following, a second embodiment of the invention will be described with reference to FIGS. 3 to 5. Constructively identical parts obtain the same reference numbers as with the first embodiment, whose description is herewith referred to. Constructively different, but functionally similar parts obtain the same reference numbers with a postpositioned a.

In the transport container 1a, units for four basic process stages are arranged, that is an LOHC pre-treatment unit 20, a dehydrogenation reactor 2a, a hydrogen conditioning unit 21 and an LOHC conditioning unit 22.

From an LOHC storage container 3a, possibly situated outside the transport container 1a, charged LOHC 15 is conducted via a line into the pre-treatment unit 20. After the pre-treatment, the release of the hydrogen takes place in the dehydrogenation reactor 2a. As the case may be, a separation of the liquid and the gaseous phase takes place already at the output of the dehydrogenation reactor 2a, wherein the liquid phase is conducted directly into the LOHC conditioning unit 22. The gaseous phase is post-treated in the hydrogen conditioning unit 21, with the result that residual portions of liquid are separated and conducted to the LOHC conditioning unit 22. The generated hydrogen 23 is conducted via a line to the hydrogen consumer 8 that is situated outside. In addition to the hydrogen consumer 8, a hydrogen storage unit may be provided.

The hydrogen 23 has a quality adapted to the hydrogen consumer 8, wherein in particular the hydrogen conditioning unit 21 is configured in such a way, in particular in a number of stages, that the quality is ensured by the necessary pressure level according to the respective application.

In the LOHC conditioning unit 22, the post-conditioning of the LOHC takes place, with the result that the discharged LOHC 24 can be stored in a second LOHC storage container 25 possibly situated outside, without special requirements to inertization or handling being imposed concerning the residual hydrogen.

As the case may be, a portion or the entire LOHC flow from the LOHC conditioning unit 22 is used for the LOHC pre-treatment unit 20 in order to manage the pre-treatment of the charged LOHC 15 by heat exchange and/or material exchange in direct contacting.

LOHC 15 that is charged and pre-conditioned in the pre-treatment unit 20 is conducted to the dehydrogenation reactor 2a via a distribution unit 14a, which is configured as a capillary plate according to the embodiment shown. The distribution unit 14a basically can also be constructed in the form of a shower head or diverse other embodiments. It is essential that the supplied, charged LOHC 15 is uniformly distributed to the catalyst mounts arranged in the housing of the dehydrogenation reactor 2a. It is further essential that dead volumes are avoided. The catalyst mounts 11 can be pipes, plates or similar mounts, which can be filled entirely or partially with catalyst on an inert carrier material and additionally be filled with further, non-catalyst-containing carrier materials in order to adapt the reaction conditions regarding the distribution of dwell time. The catalyst mounts 11 are heated by an external heating unit 13a in order to ensure an optimum heat input for the strongly endothermic reaction. This may take place via a heat carrier medium or other methods.

At least one, however typically two LOHC flows exit the dehydrogenation reactor 2a for a distribution of a mainly gaseous phase in the hydrogen conditioning unit 21 and of a liquid phase in the LOHC conditioning unit 22.

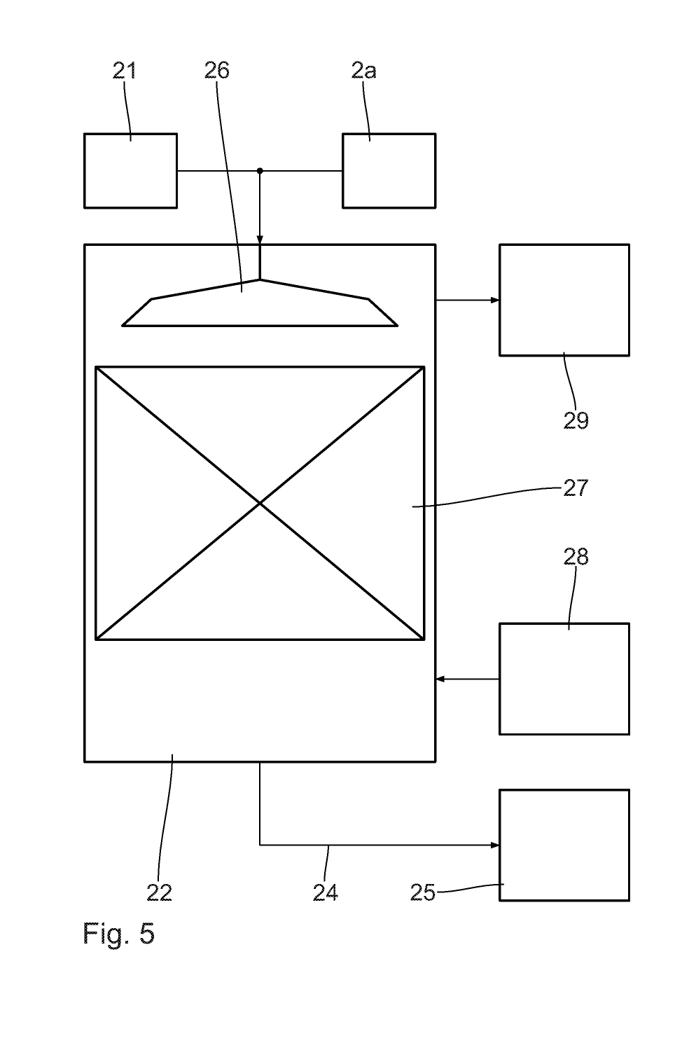

The LOHC conditioning unit 22 shown in FIG. 5 allows for an advantageous handling of the LOHC, which in particular may have a highly viscous character. The LOHC conditioning unit 22 guarantees a simple and robust separation of dissolved hydrogen.

LOHC 15 from the dehydrogenation reactor 2a or the hydrogen conditioning unit 21 is conducted into the LOHC conditioning unit 22 for LOHC conditioning. Within the LOHC conditioning unit 22, the generation of a high surface takes place by a shower head 26 as distribution unit or a distribution device of similar function. Due to the elevation of the surface of the, in particular, highly viscous LOHC, the separation of the hydrogen gas is favored. The dehydrogenation can be improved and carried out in a simplified manner.

By a packing, filling or a similar device, a high surface renewal is ensured in a subsequent stripping unit 27. A stripping gas such as air or nitrogen is supplied from a stripping gas storage 28 arranged outside and typically conducted through the stripping unit 27 in counterflow to the LOHC. The hydrogen-containing outlet flow may be supplied from an external exhaust gas purification 29, ventilation and/or combustion. Alternatively to the introduction of a gas from the stripping gas storage 28, in particular in the area of the exhaust gas purification 29, a vacuum can be set up in order to achieve an effect that is similar with regard to quality.

The LOHC 24, freed from residual hydrogen and thus ready for storage, exits the LOHC conditioning unit 22 via a separate outlet towards the second LOHC storage container 25.

While specific embodiments of the invention have been shown and described in detail to illustrate the application of the principles of the invention, it will be understood that the invention may be embodied otherwise without departing from such principles.

1. A method for providing hydrogen gas, the method comprising the process steps:
pre-heating an at least partially hydrogenated hydrogen carrier material;
releasing hydrogen gas by at least partial dehydrogenation of the at least partially hydrogen carrier material;
purifying the released hydrogen gas;
cooling and conditioning the at least partially dehydrogenated hydrogen carrier material.

2. The method according to claim 1, wherein the pre-heating of the at least partially dehydrogenated hydrogen carrier material comprises a contacting with at least one of the released hydrogen gas and the at least partially dehydrogenated hydrogen carrier material.

3. The method according to claim 1, wherein releasing the hydrogen gas takes place at a process pressure of more than 1 bar.

4. The method according to claim 1, wherein purifying the released hydrogen gas comprises separation of at least one impurity, wherein the at least one impurity is present in one of a solid aggregate state, a liquid aggregate state and a gaseous aggregate state.

5. The method according to claim 1, wherein a pressure increase by at least one of ionic compression, thermal compression and mechanical compression is provided for purifying the released hydrogen gas.

6. The method according to claim 4, wherein separation of the at least one impurity shows at least one of methods comprising coalescence precipitation, cyclone separation, adsorption separation, counterflow washer and injection into a washing liquid.

7. The method according to claim 4, wherein separation of the at least one impurity comprises a catalytic conversion of the at least one impurity.

8. The method according to claim 1, wherein purifying the released hydrogen gas takes place until an adjustable degree of purity of the hydrogen gas is achieved.

9. The method according to claim 1, wherein cooling of the at least partially dehydrogenated hydrogen carrier material takes place by an additional cooling unit.

10. The method according to claim 1, wherein after conditioning of the hydrogen carrier material a residual portion of physically dissolved hydrogen gas in the at least partially dehydrogenated hydrogen carrier material is between 1 and 10 grams ppm by weight.

11. A dehydrogenation reactor comprising:
a reactor housing,
at least one catalyst mount arranged in the reactor housing, wherein a catalyst carrier with catalyst material is arranged at the at least one catalyst mount;
a heating unit for heating the at least one catalyst mount;
a distribution unit for uniform distribution of an intake flow of at least partially hydrogenated hydrogen carrier material on the at least one catalyst mount;
at least one outlet opening for continuous discharge of hydrogen gas and at least partially dehydrogenated hydrogen carrier material from the dehydrogenation reactor.

12. The dehydrogenation reactor according to claim 11, wherein at least one of platinum, palladium, nickel, rhodium and ruthenium, each with a weight portion of 0.1% to 10% with reference to the catalyst carrier, serve as catalyst material.

13. The dehydrogenation reactor according to claim 11, wherein the catalyst carrier comprises at least one of aluminum oxide, silicon oxide, silicon carbide and activated carbon.

14. The dehydrogenation reactor according to claim 11, wherein the heating unit has one of an electric heater and a sleeve filled with at least one of liquid, vapor and gas.

15. A transport container in which a dehydrogenation reactor is arranged, the dehydrogenation reactor comprising:
a reactor housing;
at least one catalyst mount arranged in the reactor housing, wherein a catalyst carrier with catalyst material is arranged at the at least one catalyst mount;
a heating unit for heating the at least one catalyst mount;
a distribution unit for uniform distribution of an intake flow of at least partially hydrogenated hydrogen carrier material on the at least one catalyst mount;
at least one outlet opening for continuous discharge of hydrogen gas and the at least partially dehydrogenated hydrogen carrier material from the dehydrogenation reactor.

16. The method according to claim 1, wherein releasing the hydrogen gas takes place at a process temperature of more than 200° C.

17. The method according to claim 4, wherein separation of the at least one impurity into at least one separation stage is carried out.

18. The method according to claim 4, wherein separation of the at least one impurity serves for separating an impurity in a specific aggregate state.

19. The method according to claim 8, wherein purifying the released hydrogen gas takes place until a variably adjustable degree of purity of the hydrogen gas is achieved.

20. The dehydrogenation reactor according to claim 12, wherein at least one of platinum, palladium, nickel, rhodium and ruthenium, each with a weight portion of 0.1% to 10% with reference to the inert catalyst carrier, serve as catalyst material
